(19) United States
(12) Patent Application Publication
(10) Pub. No.: US 2008/0132175 A1
(43) Pub. Date: Jun. 5, 2008

(54) Method and system to support scalable application level communication between mobile device and a centralized application server

(76) Inventors: Shoshana K. Loeb, Philadelphia, PA (US); Benjamin Falchuk, Upper Nyack, NY (US)

Correspondence Address: TELCORDIA TECHNOLOGIES, INC., ONE TELCORDIA DRIVE 5G116, PISCATAWAY, NJ, 08854-4157, US

(21) Appl. No.: 11/978,763

(22) Filed: Oct. 30, 2007

Related U.S. Application Data
(60) Provisional application No. 60/855,280, filed on Oct. 30, 2006.

(51) Int. Cl. H04B 7/00; H04B 1/00

(52) U.S. Cl. 455/68

(57) ABSTRACT

A method and apparatus for limiting an amount of information transmitted between user equipment and a server. The method comprises generating local information for transmission, forwarding the local information to a filter, determining a local information type, filtering the local information based upon a preset filter criterion corresponding to the local information; and transmitting the filtered local information.

### RELATED APPLICATION

This application is related to and claims priority to U.S. Provisional Application Ser. No. 60/855,280 filed on Oct. 30, 2006.

### FIELD OF THE INVENTION

This invention relates to mobile devices, communication systems and information limiting processing.

### BACKGROUND

Mobile communication devices, such a mobile or cellular telephones have become commonplace in today's society. Most mobile telephones are no longer just used as a telephone device; rather these devices have much more sophisticated applications. For example, smartphones are capable of email, Internet access, text messaging, SMS messaging and GPS directions. Some mobile telephones are also capable of receiving location-based services. Many of the additional capabilities require a substantial amount of information to be transmitted between an application server and the mobile device. For example, the mobile device will periodically transmit informational updates to a server.

However, while the updates from the mobile devices to the server provide variable information, the updates can overload the server and the communication link there between. The overload can increase the processing power needed to process the update and increase the number of resources needed, such as storage space. Additionally, the overload can cause network interference and an increase in bandwidth needed. These problems can be prohibitive as the size of the update increases. Current systems and communication methods are not scalable. In other words, the systems and method cannot efficiently or properly account for an increase in the size of the updates.

Accordingly, there is a need to control information transmitted between a server and a mobile device.

### SUMMARY OF THE INVENTION

Accordingly, disclosed is a method for limiting an amount of information transmitted between user equipment and a server. The method comprises generating local information for transmission, forwarding the local information to a filter, determining a local information type, filtering the local information based upon a preset filter criterion corresponding to the local information, and transmitting the filtered local information. After the local information in the outgoing message is filtered, a determination is made if the filtered local information includes any information, i.e., non-empty.

The filtering can be based upon the local information type or the application source. If the filtering is based upon the local information type, the method further includes the steps of determining if the preset filter criterion is set for the local information type and filtering the update based upon the determination. If the filtering is based upon the type of update, the method further includes the step of determining if a preset filter criterion is set for the type of information and filtering the update based upon the determination. If the filtering is based upon the application source, the method includes the steps of determining a source application for the local information, determining if the preset filter criterion applies for the determination source application, and filtering the local information based upon the determination.

A server determines the preset filter criterion and transmits the filter criterion to each user equipment. The user equipment then stores the preset filter criterion. The preset filter criterion can be either time-based and/or content-based. The server also stores the preset filter criterion. The preset filter criterion is periodically updated. The updating of the preset filter criterion can occur upon receipt of the filtered local information.

Additionally, the server can transmit a customized response to the filtered local information.

The filtering can control either the size of the local information message and/or the frequency of the local information message.

The local information can be any information created or generated by the user equipment such as, but not limited to, a photograph, a list of applications running, a list of wireless access points detected, biometric data, and biological data. The preset filter criterion will correspond to the information, such as, but not limited to, a characteristic of the photograph, a characteristic of said biometric data, and a characteristic of each wireless access point.

Also disclosed is a networked artifact functioning as a server. The artifact comprises an application section for generating service information and preset filter criterion for user equipment and for the wireless server, a message formation section for creating and formatting messages, including an initial preset filter message and periodic update filter message for transmission, a storage section for storing application data and all filter criterion for user equipment and for the wireless server and local information from the user equipment, a filter for filtering information sent to the user equipment based upon the stored preset filter criterion, and a wireless transceiver for transmitting the filtered local information, the initial preset filter message and the periodic update filter message, and for receiving the local information from the user equipment.

The application section generates service information based upon the local information received from the user equipment.

Also disclosed is a user equipment used for wireless communication. The user equipment comprises application components that generate application data and local information for transmission to a server, a message formation section for creating and formatting outgoing messages, including a local information message for transmission, a storage section for storing application data, local information, and preset filter criterion, a filter for filtering the local information message based upon the preset filter criterion, and a wireless transceiver for transmitting the filtered local information message and for receiving including the preset filter criterion and updates.

### BRIEF DESCRIPTION OF THE DRAWINGS

These and other features, benefits, and advantages of the present invention will become apparent by reference to the following figures, with like reference numbers referring to like structures across the views, wherein:

FIG. 1 illustrates the communication system according to an embodiment of the invention;

FIGS. 2A and 2B illustrate an exemplary storage section for the user equipment and Server;

FIG. 3 illustrates a block diagram of the adaptive filter in accordance with an embodiment of the invention;

FIG. 4 illustrates a flow chart of a method for limiting an amount of information transmitted between user equipment and a server according to an embodiment of the invention; and

FIG. 5 illustrates a flow chart of the method for determining if a filter criterion applies to an update.

### DETAILED DESCRIPTION OF THE INVENTION

### Definitions

For purposes of the description in this application the following definitions shall apply:

“Update” shall mean a transmission of information from user equipment to a server for the purpose of a location-based service.

Server shall mean any centralized application device that receives updates from one or more user equipment.

User equipment (UE) shall mean any device capable of transmitting an update.

Location based service (LBS) shall mean any service that requires updates from a UE.

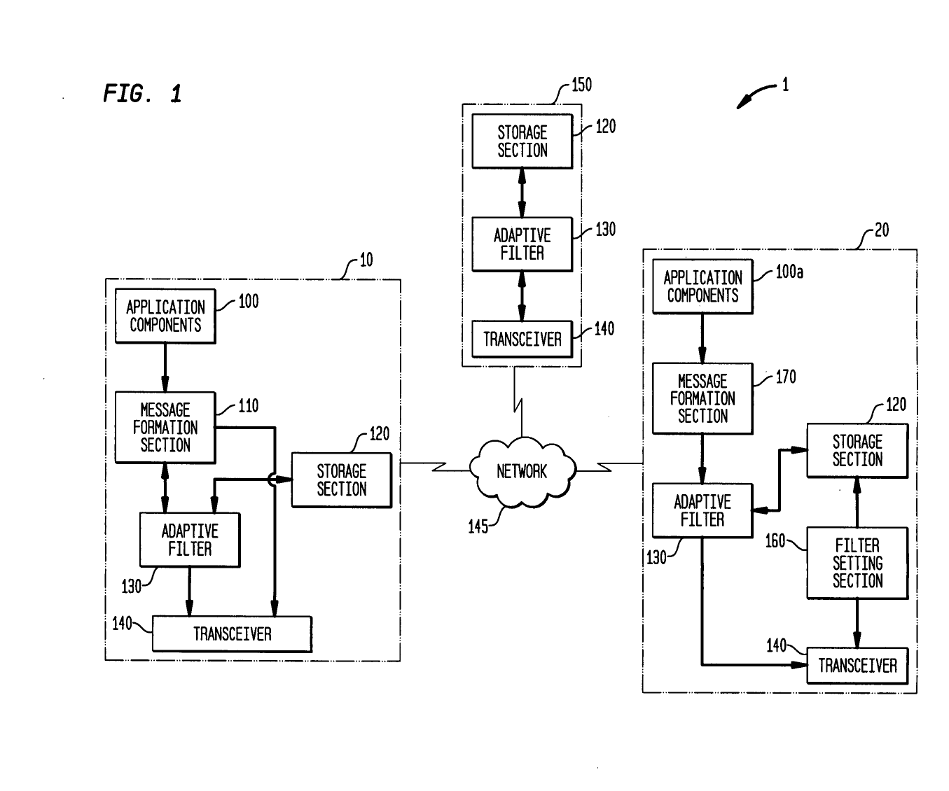

FIG. 1 illustrates an example of a communication system 1 according to an embodiment of the invention. The communication system 1 includes a UE 10, a network 145, and a server 20. The UE 10 is capable of direct transmission to the server 20. Additionally, the UE 10 can transmit data to the server 20 via an intermediary relay device 150 (which may also perform filtering).

The UE 10 can be a mobile telephone such as a smartphone. Additionally, the UE 10 can be a laptop, pager or a PDA. The server 20 can be any device including a mobile telephone. The UE 10 includes application components 100, a message formation section 110, a storage section 120, an adaptive filter 130, and a transceiver 140. The UE 10 also includes a user interface section and power source (not shown).

The application components 100 include all of the components needed to run applications such as a camera device, a Bluetooth section, Wifi adapter, a vital statistic measuring section, a telephone call receiving and generating section, sensors, text message generating section, and GPS section.

According to the invention, the application components 100 are adapted to generate updates. The updates can include the types of applications currently running, the activity currently being performed, biometric data, biological data, information related to photographs taken by the camera, networks seen, and access point connectivity.

The message formation section 110 receives the updates from the application components 100 and creates and formats an outgoing message containing the updates for potential transmission to the server 20.

The storage section 120 can be memory that is capable of having data stored and updated.

The storage section 120 includes application information, filter information and history information. The storage section 120 is in electrical communication with the adaptive filter 130.

The adaptive filter 130 is capable of controlling the size of the individual updates and controlling the temporal frequency of the updates. The adaptive filter 130 can have a local or global scope. Local scope filters are application specific filters, which are specific to the update from certain applications. Global filters apply to all updates.

The server 20 determines the filter criterion for the adaptive filter 130. The filter criterion is transmitted to the UE 10 and stored in the storage section 120. Depending on the binding of the outgoing message, the adaptive filter can directly forward outgoing message having the filtered update to a transceiver 140 or adaptive filter relays the outgoing message back to the message formation section 110. The transceiver 140 transmits and receives messages containing the updates to/from the server 20. In an embodiment, the update can be sent between the UE 10 and the server 20 using an SMS. In another embodiment, other transports can be used such as, but not limited to, a GPRS data connection, Bluetooth connection, an ad-hoc point-to-point connection with a relay server and a TCP/IP connection.

The server 20 includes many of the same elements as the UE 10 such the adaptive filter 130, the message formation section 110, and the transceiver 140. The application components 100a and the storage section 120a are similar. The difference in the storage section 120 of the UE 10 and the storage section 120a is that the storage section 120a for the server 20 also includes a service database including information from a plurality of UEs 10 (updates) and location-based information. The storage section 120a also includes filter information for both the server 20 and the UE 10. The application components 100a generate informational updates. For example, the updates can include a new network which is used to receive a discounted bill, a new number to call for local information, service locations near the UE 10, reminders, and other information related to the location.

The server 20 generates all filter criterion for the UE 10 and server 20. The filter setting section 160 determines the filter criterion for the adaptive filter 130. The filter criterion can be application specific.

The filter criterion is periodically updated, as needed. The update or modification to the filter criterion can be based upon the received update from the UE 10. In another embodiment, the server 20 updates the filter criterion based upon current or projected network conditions. The server first determines or predicts the network conditions and changes the filter criterion based upon the determination. In another embodiment, the server updates the filter criterion based upon billing or charging factors related to the individual customer to provide a customer specific filtering. In another embodiment, a combination of the network conditions and billing factors can be combined to generate or modify the filter criterion.

The initial filter criterion and updated criterion are stored in the storage section 120a. The filter criterion and updates are sent from the server 20 to the UE 10 using the transceiver 140. In another embodiment, the UE 10 periodically transmits a request for filter criterion updates.

The application components 100, message formation section 110, storage section 120 and adaptive filter 130 are in the application tier, while the transceiver 140 is in the OS tier.

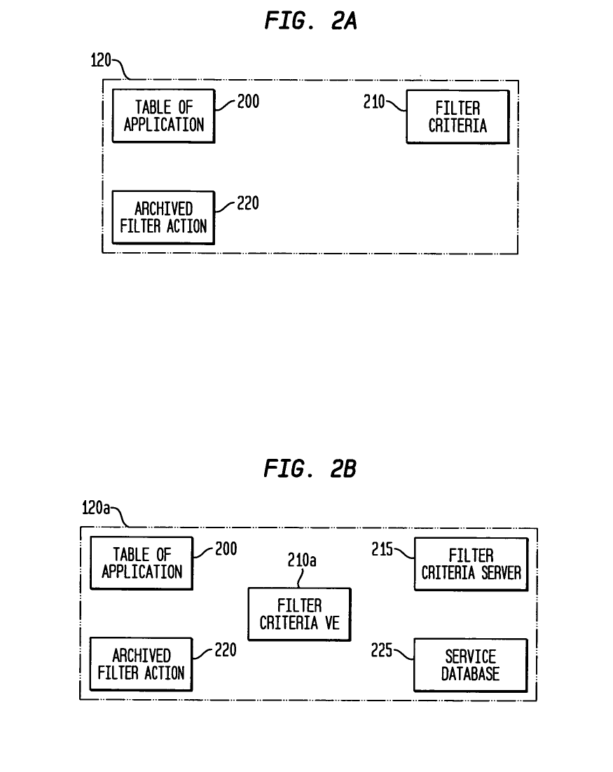

FIGS. 2A and 2B illustrate a diagram of the storage sections 120 and 120a respectively. Storage section 120 contains a table of applications for the UE 10. Additionally, the storage section 120 contains a database of the current filter criterion 210. Optionally, the database can include a history of filter criterion maintaining k-previously used criterion. In an embodiment, the history can be periodically deleted, e.g., monthly.

The storage section 120 also includes a history of the filtered action 220, i.e., a list of past filtered updates. The list is used for verifying that a current update is different from the last update. For example, if a current update is the same as the last update, the current update can be completely filtered resulting in no updates being transmitted.

Storage section 120a contains a table of applications for the server 20. Additionally, the storage section 120a contains a database of the current filter criterion 210a for the UE and a database of current filter criterion for the server. The storage section 120a also includes a history of the filtered action 220, i.e., a list of filtered updates. The list is used for verifying that a current update is different from the last update. For example, if a current update is the same as the last update, the current update can be completely filtered resulting in no updates being transmitted.

Additionally, the storage section 120a contains a service database 225. The service database 225 includes all updates received from the UEs 10.

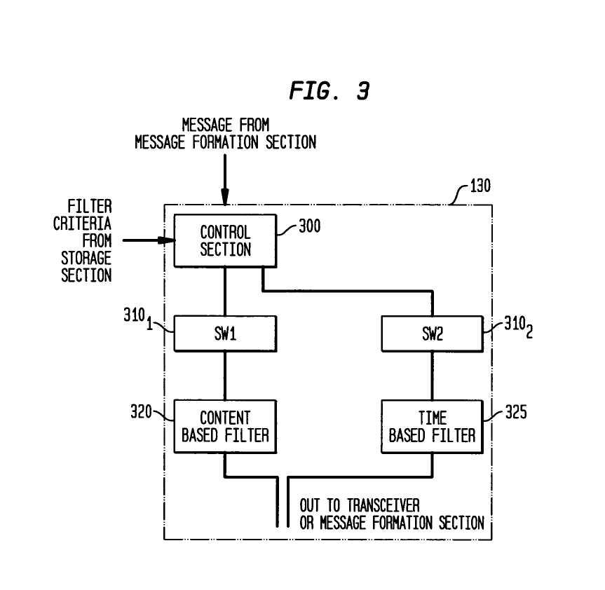

FIG. 3 illustrates a block diagram of the adaptive filter 130. The UE 10 and the server 20 have the same adaptive filter. The adaptive filter includes a control section 300 for controlling the adaptive filter 130 based upon the filter criterion and the formatted update message. The control section 300 retrieves the filter criterion from the storage section 120(120a) based upon formatted update message. The control section 300 controls switches SW1 310₁ and SW2 310₂ that direct the update message to either or both a content based filter 320 and/or a time-based filter 325. The content based filter 320 detects tokens or patterns in the update messages and removes or filters specific content based upon the filter criterion. The content-based filter 320 reduces the size of the update message, e.g., payload.

The content based filter 320 can also be used to filter out content based upon the history of the filtered action 220 retrieved from the storage section 220.

The time-based filter 325 uses a timing threshold vis-à-vis the filter criterion to reducing the communication by completely blocking out certain updates. For example, the filter criterion can be a specific number of updates within a given period of time. Additionally, the filter criterion can be that no updates should be transmitted until a given period. The determination is based upon current time, and timestamp included in the previous update in the history of the filtered action 220 retrieved from the storage section 220.

For example, if the filter criterion is that a maximum of 6 updates can be transmitted per hour, then the control section 300 will direct the updated message to the time based filter 325 closing SW 2 310₂ while opening SW1 310₁.

If the UE 10 has sent less than 6 update messages to the server 20 in the last hour, the time-based filter 325 passes the entire updated message to the transceiver 140. On the other hand, when six update messages have been transmitted, the time base filter completely filters out the message.

Furthermore, if the server 20 transmits a new filter criterion indicating that no message should be sent before 12 AM on Dec. 12, 2007, the time based filter 325 will apply the new filter criterion as a time-release gateway. The time-based filter 325 will filter out all updates, i.e., completely block every update. Both the content based filter and the time-based filter can be varied on an application basis.

For example, if the application component is a camera in the UE 10, the UE 10 can send an update of all recently taken photographs. The filter criterion can be a characteristic of the photograph such as quality of the photograph. Therefore, if the photograph is tagged as being blurry, the photograph would be filtered out and not included in the filtered update. The content based filter 320 filters out all photographs that are not of interest.

Additionally, if the UE 10 includes a biometric sensor that can sense vital signs, the UE 10 can send an update of the current vital signs. The filter criterion can be a characteristic of the vital sign, such as a range (in or out of range) or a change from the previous measurement. The content based filter 320 filters out all vital signs that are not of interest. This prevents a load waste for signs that are in range or not changed. The filters also allows for a quick determination of a problem.

If the UE 10 is capable of Wifi detection, the UE 10 can send an update of all of the current wireless access points that the UE 10 is within range, i.e., sees. The filter criterion can be a characteristic of the access point, such as seeded in the network or owned by a specific provider. The content based filter 320 filters out all access points that are not of interest. This prevents a load waste by including data that is not relevant to the server 20.

The UE 10 can also transmit an update containing all communication activity for the device, such as incoming and outgoing telephone calls. The filter criterion can be a characteristic of the telephone call or text message, such as a source or destination, e.g., no 1-800 number. The content based filter 320 filters out all telephone numbers that are not of interest. This prevents a load waste that could include telephone numbers that are not relevant or of interest to the server 20.

If the UE 10 is capable of Bluetooth, the UE 10 can send an update of all of the current devices that the UE 10 is within range, i.e., sees. The filter criterion can be a characteristic of the device. The content based filter 320 filters out all devices that are not of interest. This prevents a load waste by included data that is not relevant to the server 20.

The UE 10 can also transmit an update containing all current applications running and processor load. The filter criterion can be a characteristic of the application or a frequency of the report. The content based filter 320 filters out all applications that are not of interest. Alternatively, the time-based filter 325 can block updates such that the updates are sent only after a period of time has elapsed or sent only during a specific period of time. Additionally, a combination of the content-based filter 320 and the time based filter 325 can be used.

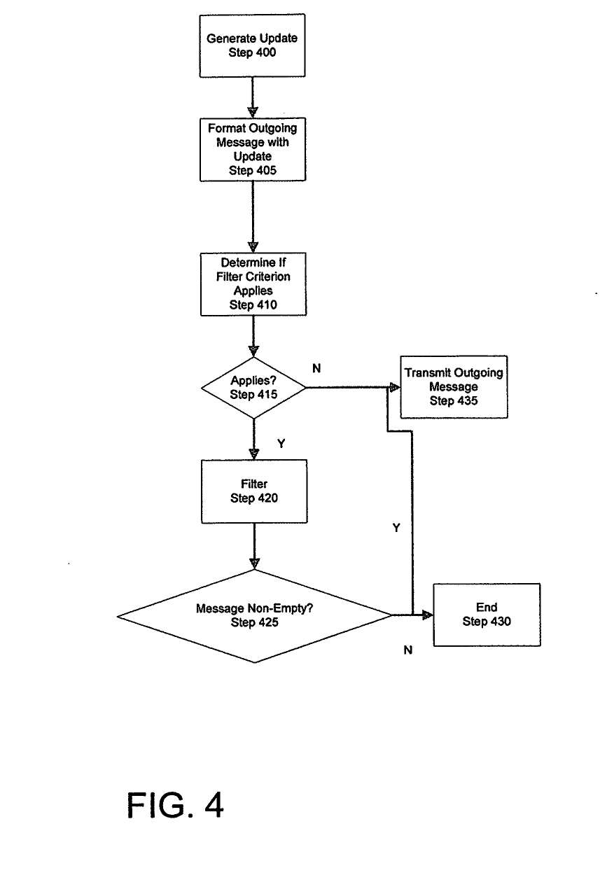

FIG. 4 illustrates a flow diagram of the method of processing an update and transmitting the update according to the invention.

At step 400, the application components 100 (100a) generate an update. The update is forward to the message formation section 110. At step 405, an outgoing message containing the update is created and formatted. The formatted outgoing message is then forwarded to the adaptive filter 130. The adaptive filter 130 determines if a stored filter criterion applies to the formed outgoing message that includes the update, at step 410. The determination will be described in detail later. If a filter criterion applies, at step 415, the process proceeds to step 420. The adaptive filter 130 filters the outgoing message containing the update using the filter criterion. The filtered outgoing message is then checked to see if the outgoing message is not empty, i.e., completely blocked, at step 425. If the filtered outgoing message does not contain any information, the process ends, at step 430. If the filtered outgoing message contains data, i.e., not empty, then the filtered outgoing message is forwarded to the transceiver for transmission at step 435.

If at step 415, the filter criterion does not apply to the formatted outgoing message containing the update, the outgoing message is forwarded to the transceiver for transmission at step 435.

The outgoing message can be optionally converted to a binary signal and/or encrypted.

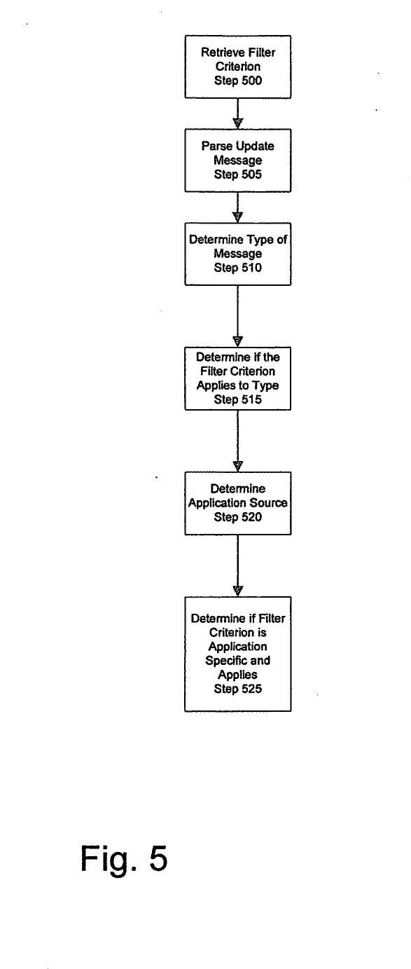

FIG. 5 illustrates a flow diagram of the method for determining if a filter criterion applies for a given formatted outgoing message containing an update.

At step 500, the control section 300 retrieves all filter criterion from the storage section 120 (120A). The control section 300 then parses the formatted outgoing message into blocks for processing, at step 505. The update contained in the outgoing message consists of a set of data. The set can contain multiple elements. The parsing separates the set into individual elements. The manner in which that parsing occurs is dependent on the type of update and the format of the data. For example, if the update contains all wireless access points detected, the set is the APs and the parsing separates the set into individual APs by name. If the update contains multiple photographs, the set is pared into data containing individual photographs.

The control section then determines the type of update contained in the outgoing message based upon the parsed blocks, at step 510. The type of update can be a textual data list, a video format data, such as jpeg or mpeg and audio data. The update can be formatted in a binary data stream. The determination of the update of update can be based upon information included in a header section of the data. Alternatively, the determination can be based upon a unique signature or pattern of the data stream. The pattern or unique signature of each type of update is stored in the storage section.

At step 515, the control section 300 determines if the determined type of update corresponds with at least one filter criterion retrieved from the storage section 120 (120A). If at least one filter criterion matches, the filter criterion is buffered.

At step 520, the control section 300 determines the application source for the update, e.g., camera. In an embodiment, the application source is determined based upon a unique tag embedded in the data. In another embodiment, the application source is inferred based upon the communication path from which the data is received. In another embodiment, the application source is determined based upon a key signature of the data. At step 525, the control section 300 then determines if a filter criterion applies to the determined application. The control section 300 controls the content based filter 320 and the time based filter 325 based upon all matched filter criterion.

### EXAMPLE

### Filtering Wifi Access Points

A UE 10 intermittently updates the server 20 on a set of wireless access points (AP) that the UE 10 detects. The service provider (SP) as set of APs deployed in the region. By transmitting updates on which APs are detected, the SP can offer customized location-based services (LBS), such as coupons, directions, local retailers, weather reports, and other local information. Additionally, a control of network flow can be achieved by balancing network traffic. The server 20 can respond by instruction the UE 10 to switch to a different network.

The application components generate the update containing all of the APs it currently detects. The list of APs can be {“linksys800”, “ACME-ap9981”, “ACMElinksys”, “my home network”}. The update is formatted into an outgoing message and forwarded to the adaptive filter 130. The adaptive filter 130 receives all filter criterion from the storage section 120. The adaptive filter 130 applies any filter criterion that corresponds to Wifi APs applications. The adaptive filter 130 modifies the update contained in the formatted outgoing message by applying the relevant filters, e.g., content based filter 320. In this example, the filter criterion for the application requires that any reported AP have an SSID that begins with the string “ACME”. All tokens that do not begin with the string “ACME” are filtered out and are not reported. Two APs are filtered out: linksys800 and my home network. The update in the outgoing message includes ACME-ap9981 and ACMElinksys.

As illustrated in FIG. 1 the adaptive filter 130 and storage section 120 are located in the UE 10; however, in another embodiment the adaptive filter 130 and storage section 120 is in the intermediary relay device 150. The intermediary relay device 150 will also include a transceiver 140. In another embodiment, multiple intermediary relay devices 150 are used as a distributed filtering system. Each intermediary relay device 150 is responsible for filtering out a specific update, based upon the filter criterion. The filter criterion in each intermediary relay device 150 compliments each other. In this embodiment, the size or frequency of the update is reduced in each intermediary relay device 150. The server 20 sends the filter criterion to each intermediary relay device 150.

In another embodiment, the storage section 120 is remotely located and accessible via the network 145 by the adaptive filter 130.

The described system and method limits the number of updates and/or the size of the updates. This results in a reduction in the power consumption for the transmission of the outgoing message containing the update. Additionally, the cost of processing and storing the update is reduced. Furthermore, the transmission resources such as channels or bandwidth are saved.

The invention has been described herein with reference to a particular exemplary embodiment. Certain alterations and modifications may be apparent to those skilled in the art, without departing from the scope of the invention. The exemplary embodiments are meant to be illustrative, not limiting of the scope of the invention, which is defined by the appended claims.

What is claimed is:

1. A method for limiting an amount of information transmitted between user equipment and a server, the method comprising the steps of:
generating local information for transmission;
forwarding the local information to a filter;
determining a local information type;
filtering the local information based upon a preset filter criterion corresponding to the local information type; and
transmitting the filtered local information.

2. The method for limiting an amount of information transmitted between user equipment and a server according to claim 1, further comprising the step of:
determining if a preset filter criterion is set for the type of local information.

3. The method for limiting an amount of information transmitted between user equipment and a server according to claim 1, further comprising the step of:
determining the preset filter criterion.

4. The method for limiting an amount of information transmitted between user equipment and a server according to claim 3, wherein said determining of the preset filter criterion is performed at the server and the server transmits said preset filter criterion to the user equipment.

5. The method for limiting an amount of information transmitted between user equipment and a server according to claim 1, further comprising the step of:
determining if the filtered local information includes any information.

6. The method for limiting an amount of information transmitted between user equipment and a server according to claim 4, further comprising the step of:
storing the preset filter criterion in the server.

7. The method for limiting an amount of information transmitted between user equipment and a server according to claim 1, wherein the preset filter criterion is content based.

8. The method for limiting an amount of information transmitted between user equipment and a server according to claim 1, wherein the preset filter criterion is time based.

9. The method for limiting an amount of information transmitted between user equipment and a server according to claim 1, wherein the preset filter criterion is content and time based.

10. The method for limiting an amount of information transmitted between user equipment and a server according to claim 1, further comprising the step of storing the filtered local information.

11. The method for limiting an amount of information transmitted between user equipment and a server according to claim 1, wherein the preset filter criterion is periodically updated.

12. The method for limiting an amount of information transmitted between user equipment and a server according to claim 1, further comprising the step of:
transmitting a customized response to the filtered local information.

13. The method for limiting an amount of information transmitted between user equipment and a server according to claim 1, further comprising the step of:
updating the preset filter criterion upon receipt of the filtered local information.

14. A user equipment used for wireless communication comprising:
application components that generate application data and local information for transmission to a server;
a message formation section for creating and formatting outgoing messages, including a local information message for transmission;
a storage section for storing application data, local information, and preset filter criterion;
a filter for filtering the local information message based upon the preset filter criterion; and
a wireless transceiver for transmitting the filtered local information message and for receiving including the preset filter criterion and updates.

15. The user equipment of claim 14, wherein said filter controls a size of the local information message.

16. The user equipment of claim 14, wherein said filter controls a frequency of transmission of the local information message.

17. The user equipment of claim 14, wherein the preset filter criterion is received from a network server.

18. A networked artifact functioning as a wireless server comprising;
an application section for generating service information and preset filter criterion for user equipment and for the wireless server;
a message formation section for creating and formatting messages, including an initial preset filter message and periodic update filter message for transmission;
a storage section for storing application data and all filter criterion for user equipment and for the wireless server and local information from the user equipment;
a filter for filtering information sent to the user equipment based upon the stored preset filter criterion; and
a wireless transceiver for transmitting the filtered localinformation, the initial preset filter message and the periodic update filter message and for receiving the localinformation from the user equipment.

19. The network artifact of claim 18, wherein said application section generates service information based upon the local information received from the user equipment.

20. The method for limiting an amount of information transmitted between user equipment and a server according to claim 1, wherein the preset filter criterion is application specific and said method further comprising the steps of:
determining a source application for the local information;
determining if the preset filter criterion applies for said determining a source application; and
filtering the local information based upon said determining if the filter criteria applies.

21. The method for limiting an amount of information transmitted between user equipment and a server according to claim 1, wherein the local information is a photograph and the preset filter criterion is a characteristic of the photograph.

22. The method for limiting an amount of information transmitted between user equipment and a server according to claim 1, wherein the local information is a list of current applications running at said user equipment.

23. The method for limiting an amount of information transmitted between user equipment and a server according to claim 1, wherein the local information is biometric data and the preset filter criterion is a characteristic of the biometric data.

24. The method for limiting an amount of information transmitted between user equipment and a server according to claim 1, wherein the local information is all detected wireless access points and the preset filter criterion is a characteristic of each detected wireless access point.
